(19) United States
(12) Patent Application Publication
(10) Pub. No.: US 2026/0236231 A1
(43) Pub. Date: Aug. 13, 2026

(54) APPLICATIONS OF RETRIEVAL-AUGMENTED GENERATION FOR SOFTWARE CODE

(71) Applicant: Microsoft Technology Licensing, LLC, Redmond, WA (US)

(72) Inventors: Jonathan Karl LARSON, Bremerton, WA (US); Darren Keith EDGE, Cambridge (GB); Christopher M. TREVINO, Bremerton, WA (US); Thu Ha TRINH, Kirkland, WA (US); Rodrigo Martins RACANICCI, Araraquara (BR)

(73) Assignee: Microsoft Technology Licensing, LLC, Redmond, WA (US)

(21) Appl. No.: 19/050,955

(22) Filed: Feb. 11, 2025

(51) Int. Cl. G06F 8/30

(52) U.S. Cl. CPC G06F 8/30

(57) ABSTRACT

This document relates to processing of source code using generative language models. One example method includes accessing source code, processing the source code to identify entities in the source code, and generating a graph having nodes representing the entities in the source code and edges representing relationships among the entities. The example method also includes prompting a generative language model to generate augmentation data for the entities based at least on the relationships, receiving, from the generative language model, generated augmentation data, and generating an augmented graph by associating the generated augmentation data with respective nodes of the graph. The augmented graph provides a basis for subsequent operations on the source code by the generative language model.

### BACKGROUND

In recent years, generative machine learning models have demonstrated tremendous capability at generating natural language content. For instance, generative language models can generate text to summarize existing documents, help users draft new documents, and conduct natural language conversations with users at a very high level. However, generative machine learning models still have certain drawbacks. For instance, generative language models can utilize significant computational resources (e.g., processor, memory, network, etc.). In addition, generative machine learning models sometimes have difficulty performing complex analytical tasks.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to source code processing using generative language models. One example includes a computer-implemented method that can include receiving a request to perform an operation on source code having entities, the request identifying a particular entity in the source code. The method can also include accessing a graph having nodes representing the entities in the source code and edges representing relationships among individual entities. The method can also include resolving dependencies of the particular entity by traversing the graph. The method can also include generating a prompt requesting a generative language model to perform the operation, the prompt being based at least on the requested operation and the dependencies. The method can also include inputting the prompt to the generative language model. The method can also include receiving, from the generative language model, output corresponding to the requested operation.

Another example entails a system that includes a processor and a storage medium storing instructions. When executed by the processor, the instructions can cause the system to receive a request to perform an operation on source code having entities, the request identifying a particular entity in the source code. The instructions can also cause the system to access a graph having nodes representing the entities in the source code and edges representing relationships among individual entities. The instructions can also cause the system to resolve dependencies of the particular entity by traversing the graph. instructions can also cause the system to generate a prompt requesting a generative language model to perform the operation, the prompt being based at least on the requested operation and the dependencies. The instructions can also cause the system to input the prompt to the generative language model. The instructions can also cause the system to receive, from the generative language model, output corresponding to the requested operation.

Another example includes a computer-readable storage medium storing instructions which, when executed by a processing device, cause the processing device to perform acts. The acts can include receiving a request to perform an operation on source code having entities, the request identifying a particular entity in the source code. The acts can include accessing a graph having nodes representing the entities in the source code and edges representing relationships among individual entities. The acts can include resolving dependencies of the particular entity by traversing the graph. The acts can include generating a prompt requesting a generative language model to perform the operation, the prompt being based at least on the requested operation and the dependencies. The acts can include inputting the prompt to the generative language model. The acts can include receiving, from the generative language model, output corresponding to the requested operation.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of source code in a computer programming language, consistent with some implementations of the present concepts.

FIG. 2 illustrates an example of an abstract syntax tree, consistent with some implementations of the present concepts.

FIG. 3 illustrates an example of a code graph, consistent with some implementations of the present concepts.

FIGS. 4A-4F illustrate an example of constructing a directed acyclic graph representing entities in source code, consistent with some implementations of the present concepts.

FIGS. 5A-5E illustrate an example of augmenting a directed acyclic graph representing entities in source code, consistent with some implementations of the present concepts.

FIGS. 6A-6G illustrate examples relating to subsequent operations that can be performed on source code using an augmented directed acyclic graph, consistent with some implementations of the present concepts.

FIG. 7 illustrates an example of a system in which the disclosed implementations can be performed, consistent with some implementations of the present concepts.

FIG. 8 illustrates an example method or technique, consistent with some implementations of the disclosed techniques.

FIG. 9 illustrates an example generative language model, consistent with some implementations of the present concepts.

### DETAILED DESCRIPTION

As noted above, generative language models exhibit the ability to generate language content for a wide range of applications. For instance, generative language models can generate natural language in a relatively unstructured (e.g., conversational) format, and can also generate more structured content, such as computer programming code. One way to improve the ability of a generative language model for certain tasks involves retrieval-augmented generation. In retrieval-augmented generation, user queries are used to retrieve external documents, and those documents can be provided to the generative language model. The generative language model can use the information from the external documents to assist in answering the query.

However, in some cases, a given task may involve complex analytical steps over retrieved information. For instance, when the retrieved documents are written in natural language by human users, the documents tend to lack inherent structure. This lack of structure can cause generative language models to produce poor-quality (e.g., inaccurate or irrelevant) output when analyzing natural language documents.

Unlike natural language, however, computer programming code (i.e., source code) has explicit structural relationships. In theory, a generative language model could utilize these explicit relationships to provide more useful, accurate outputs when processing source code. For instance, a naïve approach to processing source code with a generative language model might involve providing an entire codebase to the generative language model to achieve a task, such as translating the codebase into a different programming language or summarizing the codebase. However, this approach is impractical in most cases, as the codebase will likely exceed the context window limitations of the generative language model. Furthermore, while generative language models can effectively analyze relatively simple examples of source code, they are not particularly adept at understanding structural relationships expressed in more complex source code.

The disclosed implementations can leverage explicit relationships in source code to improve the ability of a generative language model to analyze the source code. For instance, source code can first be represented by a data structure, such as a graph, that represents relationships among entities, such as functions, classes, files, variables, etc. Then, the graph can be augmented by the generative language model with augmentation data, such as summaries of individual entities in the source code. The augmented graph can be used as a basis for subsequent operations on the source code, as discussed more below.

### Machine Learning Overview

There are various types of machine learning frameworks that can be trained to perform a given task. Support vector machines, decision trees, Kolmogorov-Arnold networks, state space models, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “source code,” as used herein, refers to computer programming code written in a language used by human developers. Example source code languages include procedural languages such as C, Pascal, and Fortran, object-oriented languages such as C++, C#, Python, Java, and Rust, functional languages such as Lisp and Scheme, assembly languages for various processor architectures such as x86 and ARM, markup languages such as HTML and XML, etc.

The term “entities” in relation to source code refers to constructs such as functions, classes, variables, files, etc. The term “relationship” refers to any association between two entities in a given body of source code. For instance, one type of relationship is a direct parent-child relationship, which can be inferred from containment of one entity by another. For instance, when a source code file contains functions, classes, or variables, those entities are children of the parent source code file. Another example of a parent-child relationship is when a parent class contains a function or member as a child of that parent class, or a parent function contains a local definition of a variable that is a child of that parent function. Another type of relationship is a transitive relationship, where a given first entity has a transitive dependency, via a second entity, on a third entity. For instance, the first entity can be a parent of the second entity and the second entity can be a parent of third entity. In other cases, a transitive dependency can be formed by a chain of multiple intermediate entities. In addition to parent-child relationships, other types of relationships can exist, such as when one function calls another function or one variable is a member of another data structure.

The term “augmentation data” refers to data relating to any entity or relationship between entities in source code. For instance, augmentation data can include a summary of an entity. In some cases, summaries are hierarchical, e.g., a summary of one entity can include a description of one or more other entities that have a relationship with that entity. Augmentation data such as summaries can be generated by a generative model, such as a generative language model. Augmentation data can also include tags generated by a generative language model that describe some aspect of an entity, such as “service,” “model,” “memory,” or “FeatureXYZ.” Tags can be used to categorize individual source code entities as discussed more below.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. Another type of input to a generative language model includes a natural language request for the generative language model to perform operations on other information, such as source code. A generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Source Code Processing Example

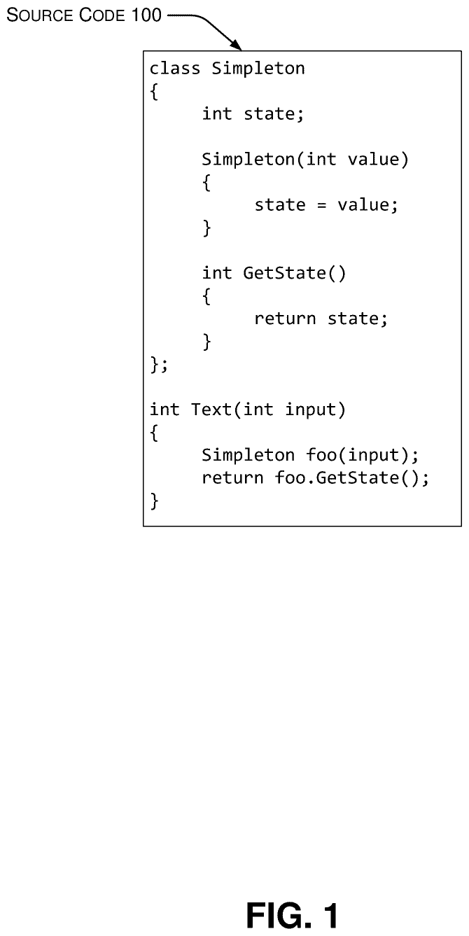

FIG. 1 shows example source code 100. The source code includes entities such as a Simpleton class and a Text() function. The Simpleton class includes further entities such as a Simpleton() function, a GetState() function, and a state variable.

Source code 100 is provided as a relatively simple example to illustrate certain concepts described herein. Here, the Simpleton class includes dependencies on the Simpleton() function, the GetState() function, and the state variable. The Text() function includes dependencies on the Simpleton class, the input argument, and the GetState() function.

Because source code 100 is a simple example, it is possible to identify these relationships by simply reading the source code. However, in more complicated source code examples, it is not practical for a human to simply read source code to identify a comprehensive set of entities and relationships. The following describes a programmatic approach to doing so.

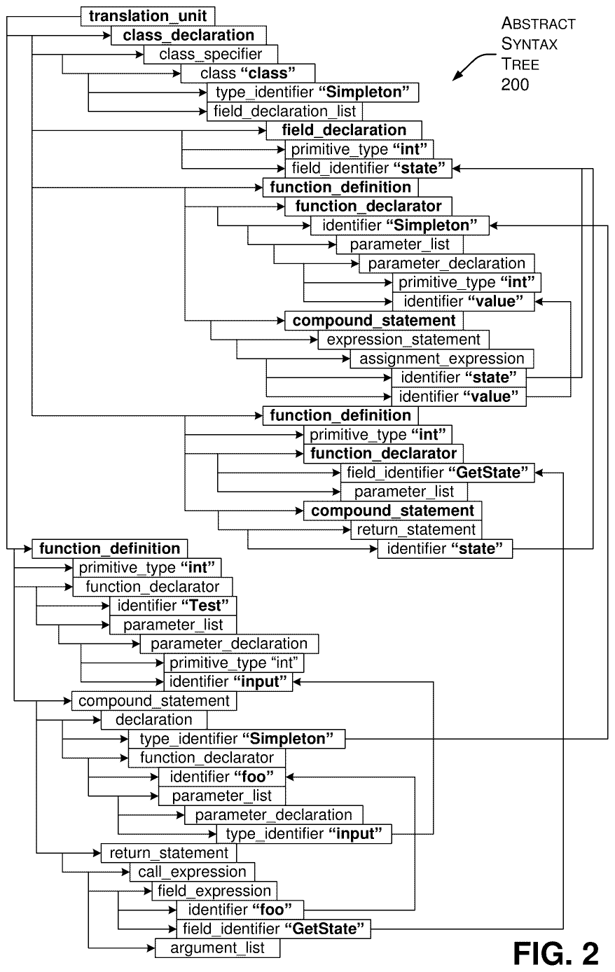

One way to extract entities and relationships from the source code 100 is to start by generating an abstract syntax tree. FIG. 2 shows an example abstract syntax tree 200, representing source code 100. An abstract syntax tree can be generated by processing source code using a development tool, such as a compiler, an AST module (e.g., for Python), a parser, etc. Note that, despite the relative simplicity of source code 100, abstract syntax tree 200 is quite complex. While the abstract syntax tree represents relationships among entities in the source code, it can be impractical to directly use the abstract syntax tree to guide a generative language model to generate augmentation data for the source code.

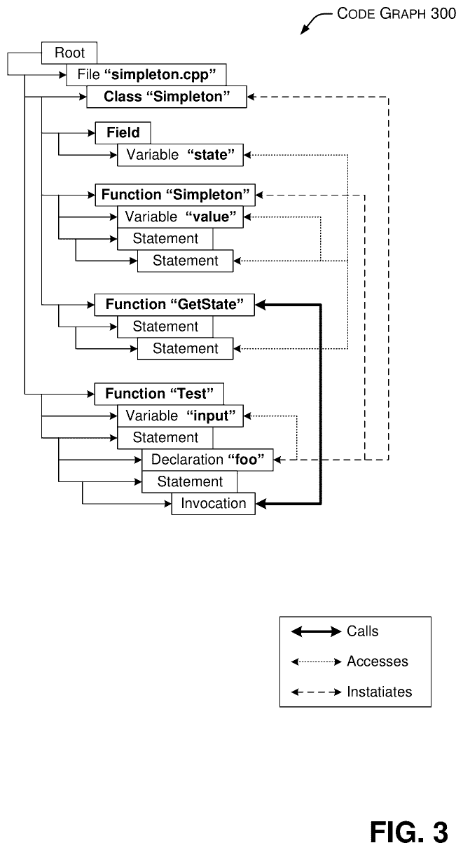

Abstract syntax tree can be processed using one or more rules or heuristics to remove certain entities. The result can be a code graph. FIG. 3 shows an example code graph 300 derived from abstract syntax tree 200. Note that the code graph includes far less information than the abstract syntax tree, as constructs such as parameter lists, identifiers, assignment expressions, etc. have been removed. The code graph still includes high-level information about entities such as functions, classes, variables, and files, however. Thus, a code graph can be useful as a starting point to identify entities in a given source code base for subsequent processing, as described further below.

### Example Directed Acyclic Graph Generation

The following discussion introduces a somewhat more complex example of source code to illustrate certain concepts. Consider a program that includes a main() function. The main() function instantiates two classes—a Game class and a GameConfig class. The GameConfig class instantiates two other classes—a PlayerConfig class and a ScreenConfig class. Even with such a simple example, an abstract syntax tree for such a program would be far too large to illustrate in a single figure. However, by starting from an abstract syntax tree representing the program and then distilling the abstract syntax tree into a code graph as described above, each of these entities could be extracted from the program. The following discussion illustrates how to proceed with construction of a directed acyclic graph once the entities are identified.

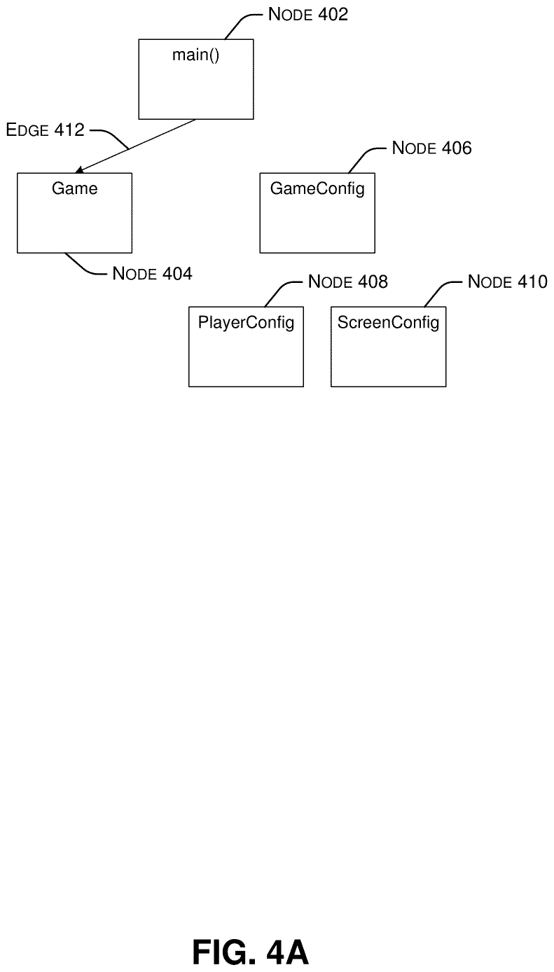

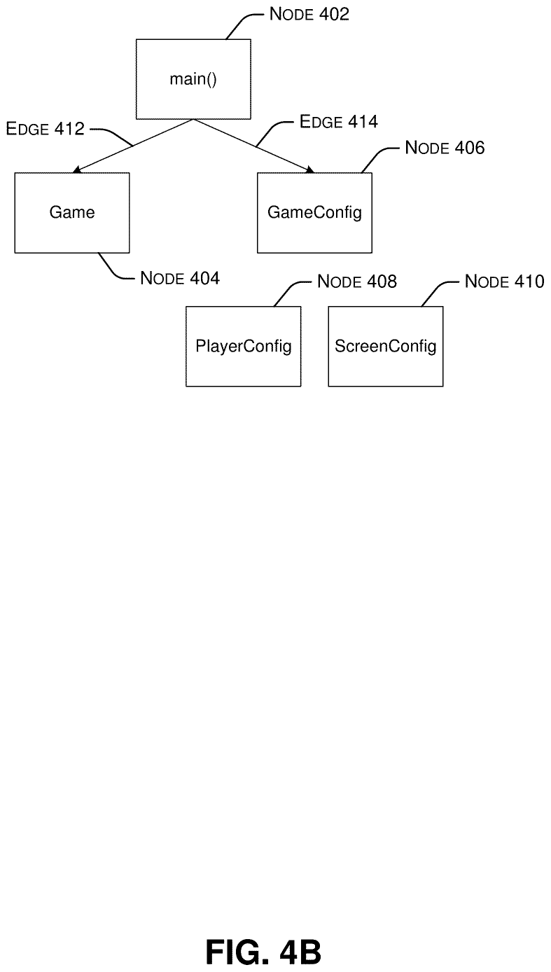

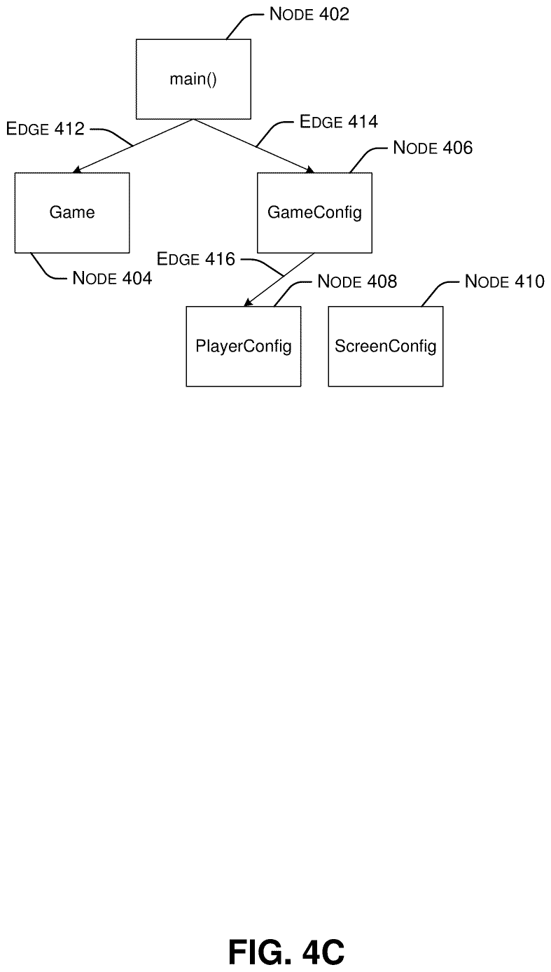

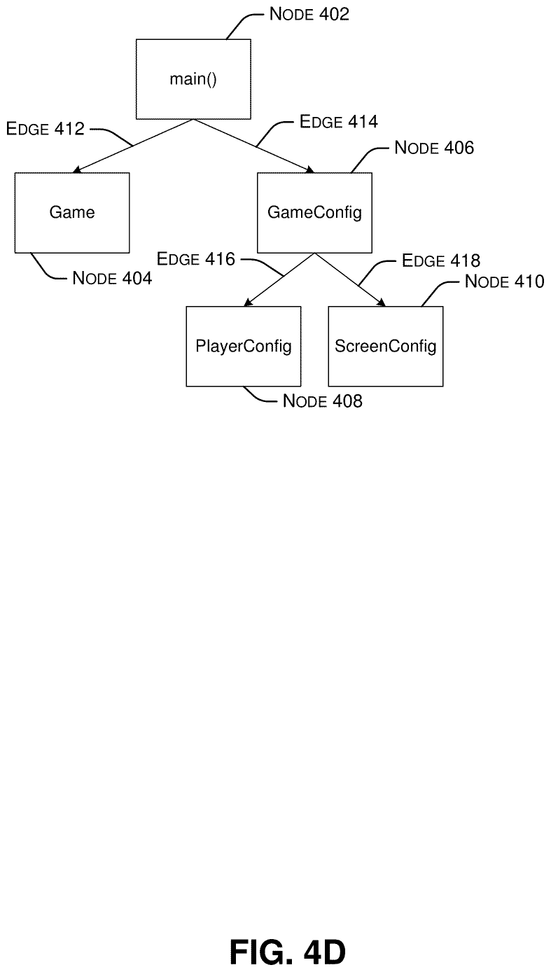

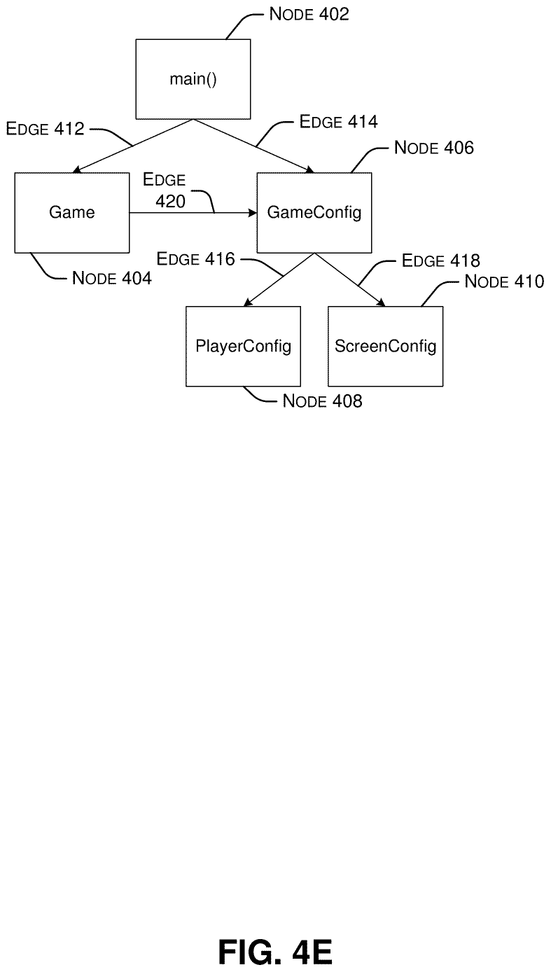

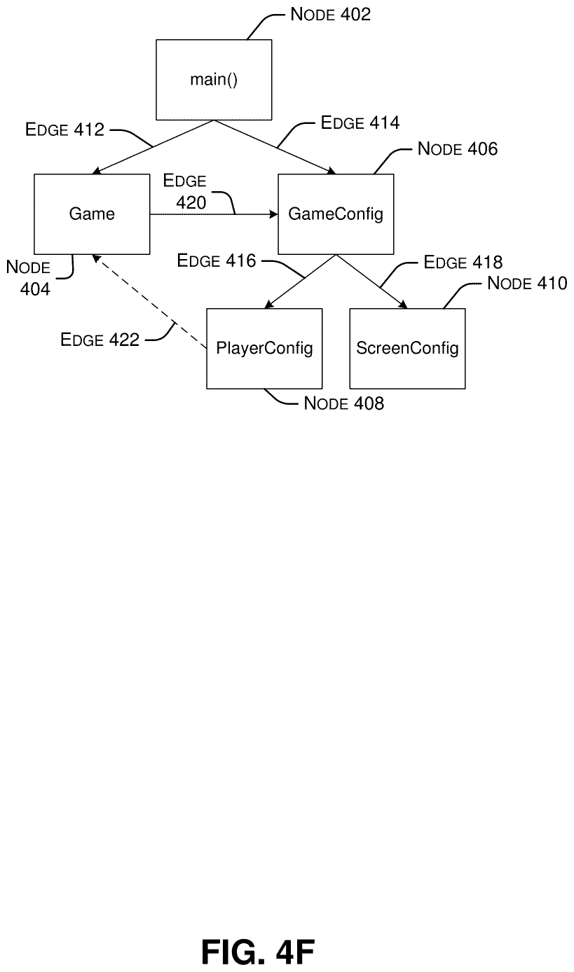

FIGS. 4A-4F show an example of how a directed acyclic graph can be constructed for this source code example. First, entities can be represented as nodes. As shown in FIG. 4A, node 402 represents the main() function, node 404 represents the Game class, node 406 represents the GameConfig class, node 408 represents the PlayerConfig class, and node 410 represents the ScreenConfig class.

Next, edges can be inserted in the graph for each parent-child dependency in the source code. As shown in FIG. 4A, edge 412 is inserted between node 402, representing the main() function, and node 404, representing the Game class. Here, edge 412 represents the fact that the main() function has a parent-child dependency on the Game class, because the main() function creates a local instance of the Game class.

Next, as shown in FIG. 4B, edge 414 is inserted between node 402, representing the main() function, and node 406, representing the GameConfig class. Here, edge 414 represents the fact that the main() function has a parent-child dependency on the GameConfig class, because the main() function creates a local instance of the Game class.

Next, as shown in FIG. 4C, edge 416 is inserted between node 406, representing the GameConfig class, and node 408, representing the PlayerConfig class. Here, edge 416 represents the fact that the GameConfig class has a parent-child dependency on the PlayerConfig class, because the GameConfig class includes a member that is an instance of the PlayerConfig class.

Next, as shown in FIG. 4D, edge 418 is inserted between node 406, representing the GameConfig class, and node 410, representing the ScreenConfig class. Here, edge 418 represents the fact that the GameConfig class has a parent-child dependency on the ScreenConfig class, because the GameConfig class includes a member that is an instance of the ScreenConfig class.

Next, as shown in FIG. 4E, edge 420 is inserted between node 404, representing the Game class, and node 406, representing the GameConfig class. Here, edge 420 does not necessarily represent a parent-child relationship, but rather a more indirect relationship. For instance, the Game class could include a function that receives an instance of the GameConfig class as an argument.

Next, as shown in FIG. 4F, edge 422 is inserted between node 408, representing the PlayerConfig class, and node 404, representing the Game class. Edge 422 may represent an indirect or transitive relationship, e.g., the PlayerConfig class may be a member of the GameConfig class, which the Game class receives as an argument. In this case, however, edge 422 will be removed because it creates a cycle in the graph.

In some implementations, edges can be added between nodes in a particular order. First, all edges for all parent-child dependencies can be added. Then, edges for other (non parent-child) relationships can be added in an order that is based on a heuristic. For instance, one type of heuristic is a link-based heuristic that considers the extent to which entities link to one another, directly or indirectly. Generally speaking, entities that are at deeper levels of the code base and invoked broadly by many other entities in the code base will tend to have higher values for such a heuristic. Scores can be calculated for each entity, and then edges to individual entities can be sorted and added in order based on the scores. Thus, edges connecting entities that have relatively higher values for the link-based heuristic can be prioritized over edges connecting entities with relatively lower values for the link-based heuristic.

### Example Graph Augmentation

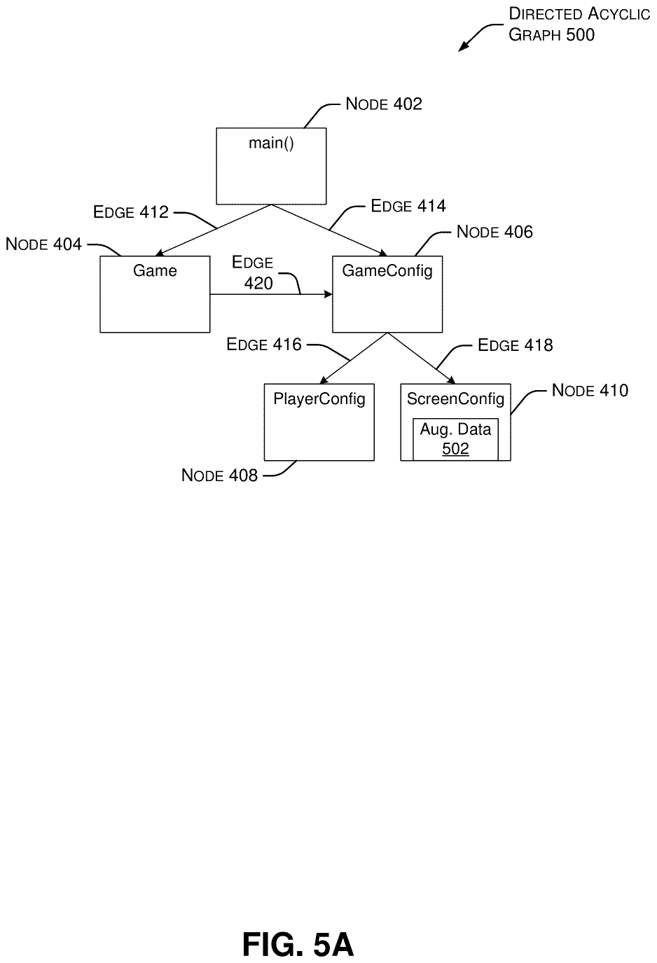

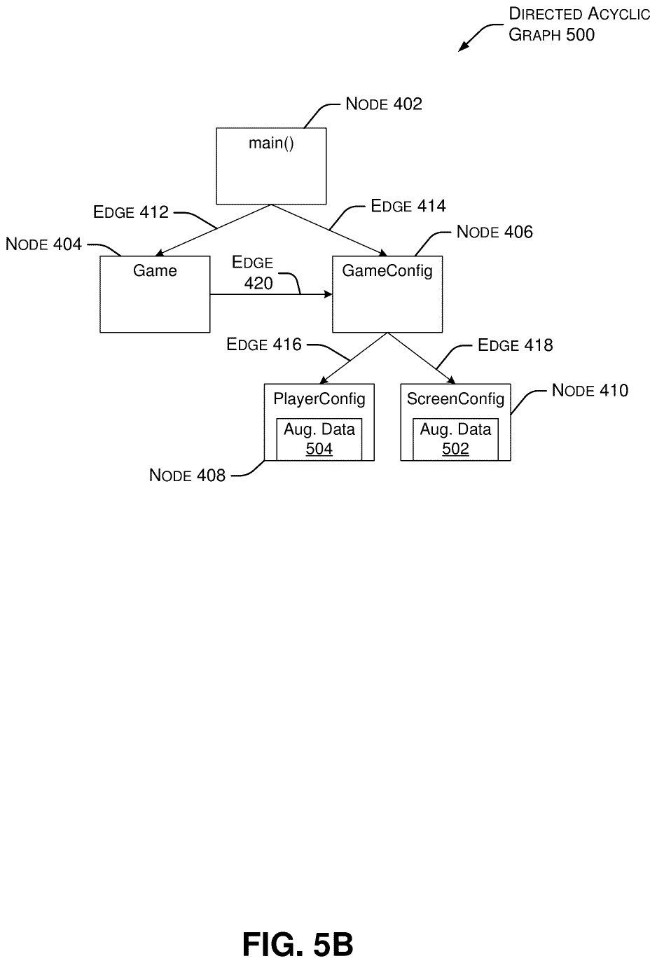

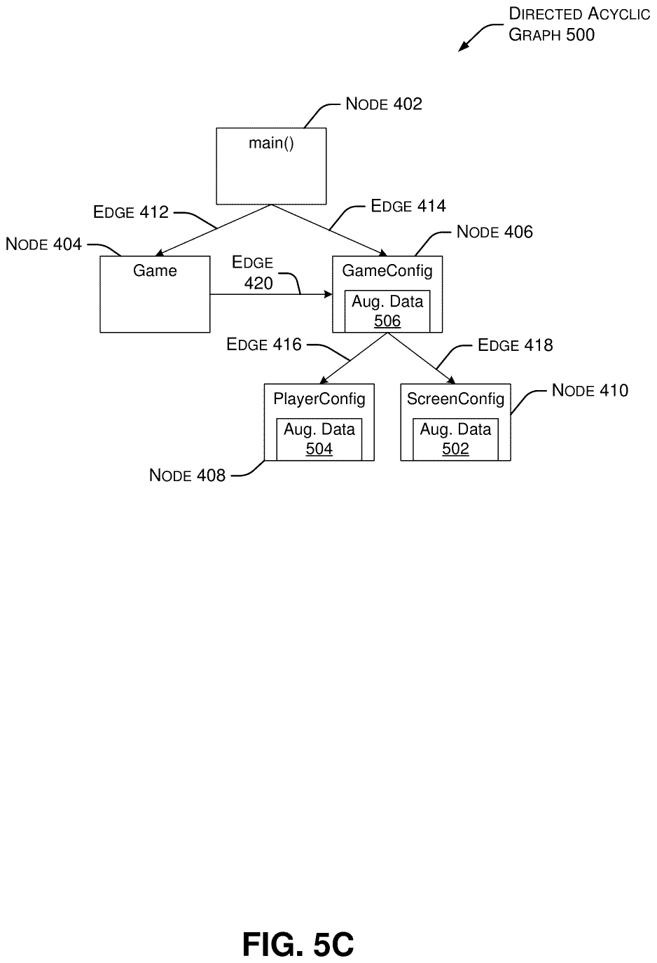

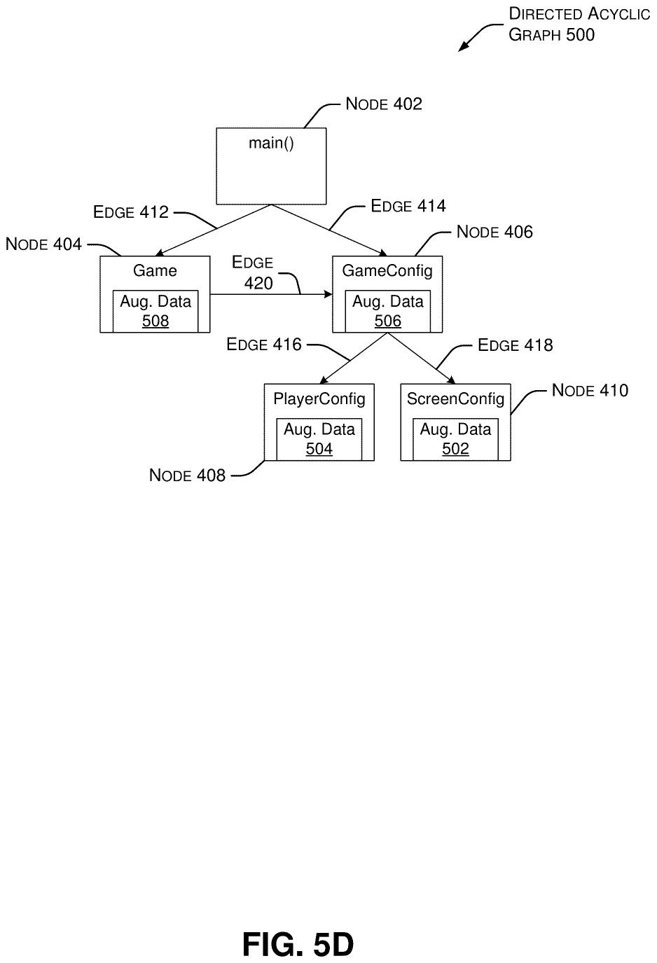

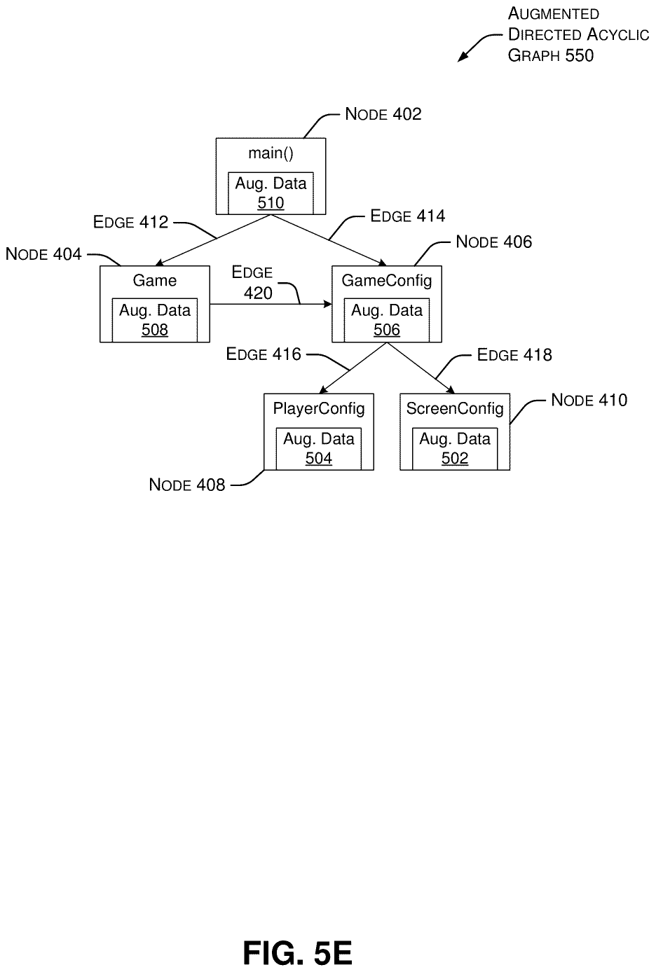

Referring back to FIG. 4E, note that the figure depicts a directed acyclic graph that can be used as a basis for augmentation, as described below. FIGS. 5A-5E illustrate an example of augmenting the directed acyclic graph. As shown in FIG. 5A, directed acyclic graph 500 can result from the processing described previously. Next, a reverse topological sort can be performed on the nodes of the directed acyclic graph. Assume for the following example that the reverse topological sort results in the following ordering—node 410, node 408, node 406, node 404, and node 402

Starting with node 410, augmentation data 502 can be generated as shown in FIG. 5A. For instance, augmentation data 502 can be generated by prompting a generative language model to summarize the ScreenConfig class. The prompt can include the source code for the ScreenConfig class. The augmentation data 502 generated by the generative language model could be “The ScreenConfig class configures display characteristics such as screen height, width, and margins, as well as framerate.”

Proceeding to node 408, augmentation data 504 can be generated as shown in FIG. 5B. For instance, augmentation data 504 can be generated by prompting a generative language model to summarize the PlayerConfig class. The prompt can include the source code for the PlayerConfig class. The augmentation data 504 generated by the generative language model could be “The PlayerConfig class configures player characteristics such as a position ratio for the player, a maximum height that the player can jump, and a representation of the player as a circle.”

Proceeding to node 406, augmentation data 506 can be generated as shown in FIG. 5C. For instance, augmentation data 506 can be generated by prompting a generative language model to summarize the GameConfig class. The prompt can include the source code for the GameConfig class. The prompt can also include augmentation data for nodes dependent on node 406, e.g., augmentation data 502 from node 410 and augmentation data 504 from node 408. Alternatively or in addition, the prompt can also include the source code represented by those nodes, e.g., the source code of the ScreenConfig class and/or the PlayerConfig class, respectively. The augmentation data 506 generated by the generative language model could be “The GameConfig class creates an instance of the ScreenConfig class, which specifies display characteristics such as screen height, width, and margins, as well as framerate. The GameConfig class also creates an instance of the PlayerConfig class, which configures player characteristics such as a position ratio for the player, a maximum height that the player can jump, and a representation of the player. The GameConfig class also defines variables for incrementing a score by five points and decrementing the score by 10 points.”

Proceeding to node 404, augmentation data 508 can be generated as shown in FIG. 5D. For instance, augmentation data 508 can be generated by prompting a generative language model to summarize the Game class. The prompt can include the source code for the Game class. The prompt can also include augmentation data for nodes directly or indirectly dependent on node 404, e.g., augmentation data 506 from node 406, augmentation data 502 from node 410 and augmentation data 504 from node 408. Alternatively or in addition, the prompt can also include the source code represented by those nodes, e.g., the source code of the GameConfig class, the ScreenConfig class and/or the PlayerConfig class, respectively. The augmentation data 508 generated by the generative language model could be “The Game class initializes the game with the GameConfig class. The Game class also creates an instance of a game player and sets their score to 0.”

Proceeding to node 402, augmentation data 510 can be generated as shown in FIG. 5E. For instance, augmentation data 510 can be generated by prompting a generative language model to summarize the main() function. The prompt can include the source code for the main() function. The prompt can also include augmentation data for nodes directly or indirectly dependent on node 404, e.g., augmentation data 508 from node 404, augmentation data 506 from node 406, augmentation data 502 from node 410 and augmentation data 504 from node 408. Alternatively or in addition, the prompt can also include the source code represented by those nodes, e.g., the source code of the Game class, the GameConfig class, the ScreenConfig class and/or the PlayerConfig class, respectively. The augmentation data 510 generated by the generative language model could be “The main() function is an entry point for running the game, and uses the Game and GameConfig classes over a loop. The GameConfig object specifies screen settings using the ScreenConfig class, and player settings using the PlayerConfig class. The GameConfig object is passed to the Game object to configure the behavior of the game.”

Once all of the augmentation data has been added to the directed acyclic graph 500, the result is augmented directed acyclic graph 550. Note that the augmentation data from deeper layers of the graph allows information to propagate upward toward the root of the graph. For instance, because augmentation data 506 includes generated descriptions of the PlayerConfig and ScreenConfig classes, this information is carried up the hierarchy and included when prompting the generative language model to generate augmentation data 510 for the main() function.

### Subsequent Operations

Once augmented directed acyclic graph 550 has been created, the graph can serve as a data structure for guiding retrieval-augmented generation by the generative language model. Generally, this can proceed as follows. First, assume a query is directed to a particular node U the graph. Next, a breadth-first search over the graph can be implemented as follows:
1. Initialize an empty set R to store the results.
2. Set the depth to 0.
3. Identify all nodes V that have a direct edge from U to V. These represent the immediate neighbors of U and can be added to the result set R.
4. Increment the depth and repeat the process for the newly discovered neighbors.
5. Continue this process until no more neighbors are found or a specified maximum depth is reached.
   In addition, the following rules can be employed for specific use cases:
If the node represents a method within a class, augmentation data and/or source code from the parent class is included.
If the node represents a file, information about the dependencies of each node within the file should be gathered.

At this point, a prompt can be generated to perform a task using the augmentation data for each node in the resulting set of nodes R. The prompt can also include the source code for each node in R. For instance, the prompt can request that the generative language model translate each node in R into a different programming language, refactor each node in R to use a different application programming interface, generate unit tests for each node in R, enhancing existing unit tests for each node in R, transform code for each node in R (e.g., to use heap memory instead of global memory), fix bugs for each node in R, and/or generate documentation for each node in R (e.g., add comments to the source code and/or generate a separate document describing the code).

To further appreciate how the disclosed implementations can improve the ability of a generative language model to perform operations on source code, consider a much larger code example with hundreds or thousands of nodes in an augmented directed acyclic graph. It is unlikely that the entire source code base and/or all of the augmentation data in the graph could fit into the context window of the generative language model. Even if the context window could accommodate all of the information, the generative language model would likely generate inaccurate results because there is simply too much information for the generative language model to accurately analyze.

Using the disclosed techniques, a limited number of nodes and associated augmentation data and/or source code can be selected for the generative language model to process. By leveraging the existing dependency structures found in the source code, the disclosed techniques can accurately filter out extraneous information from unrelated portions of the code base, only prompting the generative language model with information that is pertinent to one or more nodes of interest. Moreover, because the augmentation data is hierarchical in nature, salient information from deeper layers of the graph can be provided to the generative language model even from nodes that are not necessarily included in the result set.

In addition, note that the preceding examples described the use of summaries as augmentation data. However, as also noted, another example of augmentation data involves a tag generated by a generative language model. Tags can be used to group related nodes together and add those related nodes to the set R prior to performing the breadth-first search described above. Thus, for example, consider a tag “DynamicMemory” assigned to each source code entity that uses dynamic memory allocation at runtime. By grouping all of these nodes together and then performing the breadth-first search described above, a subset of entities of a source code base that use dynamic memory or depend on entities that use dynamic memory can be processed together. For instance, the generative language model could be prompted to generate unit tests for that subset of entities to exercise all of the memory allocation/deallocation code with null pointers or out-of-range memory values to ensure comprehensive coverage of the code base, without considering other source code entities that are not closely involved with dynamic memory allocation/deallocation.

### Example Source Code Operations

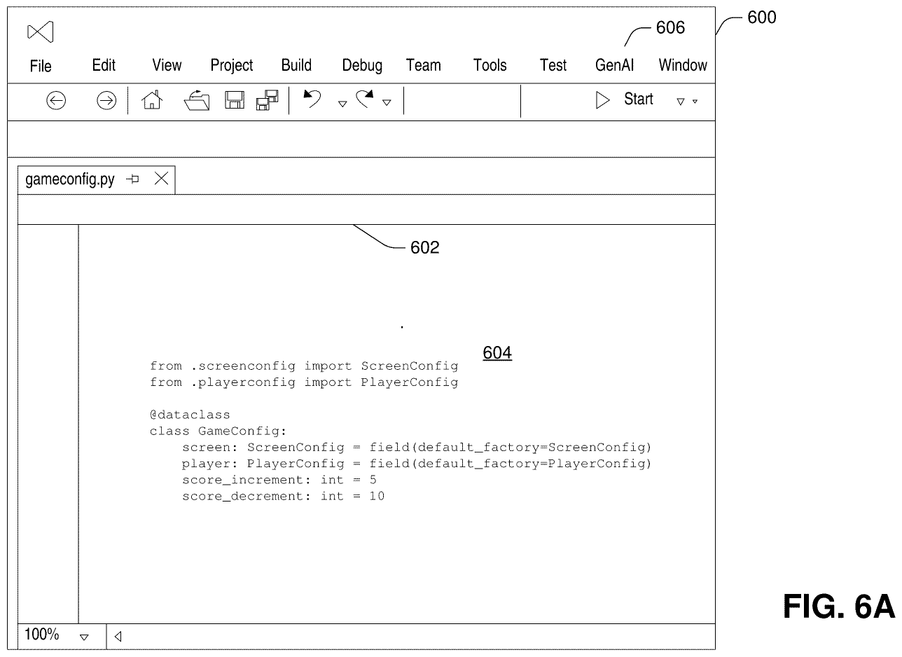

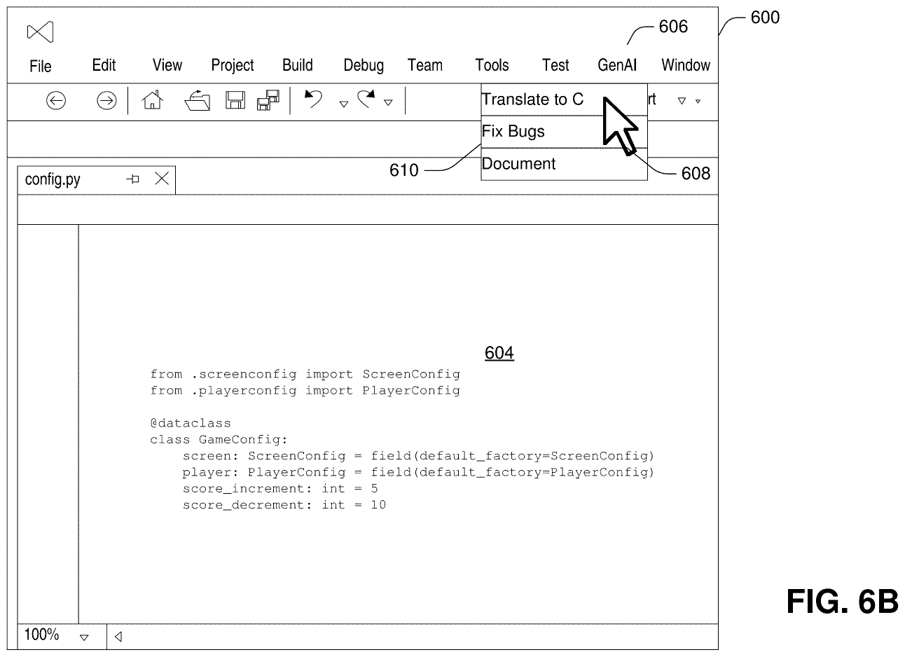

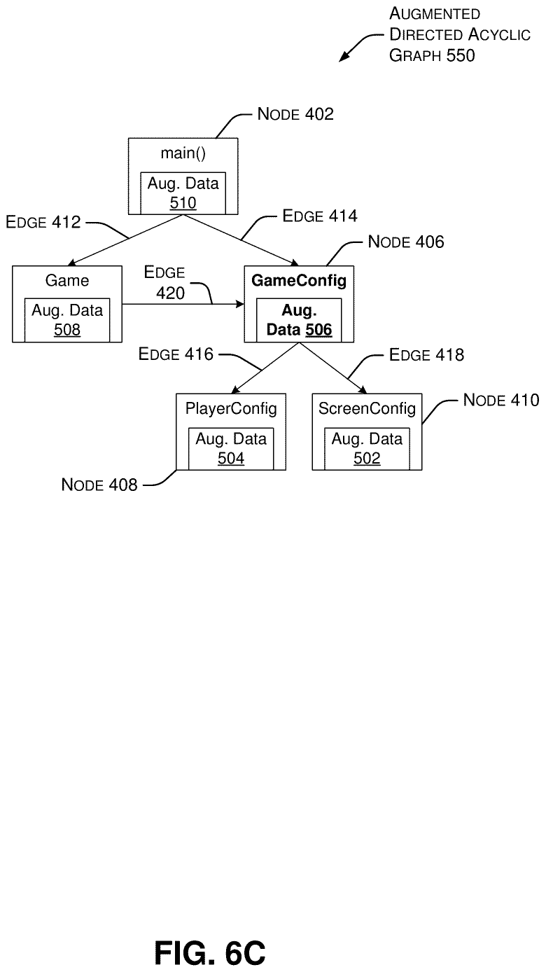

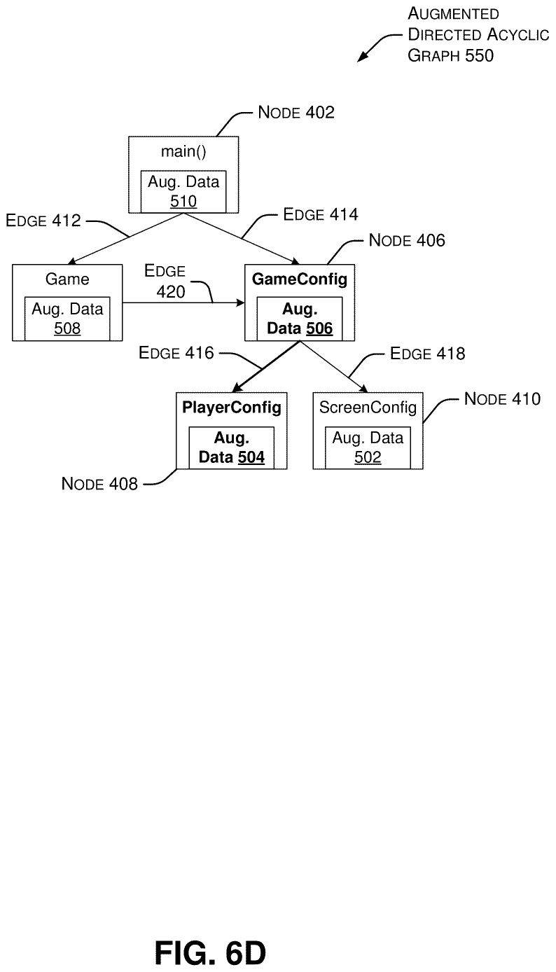

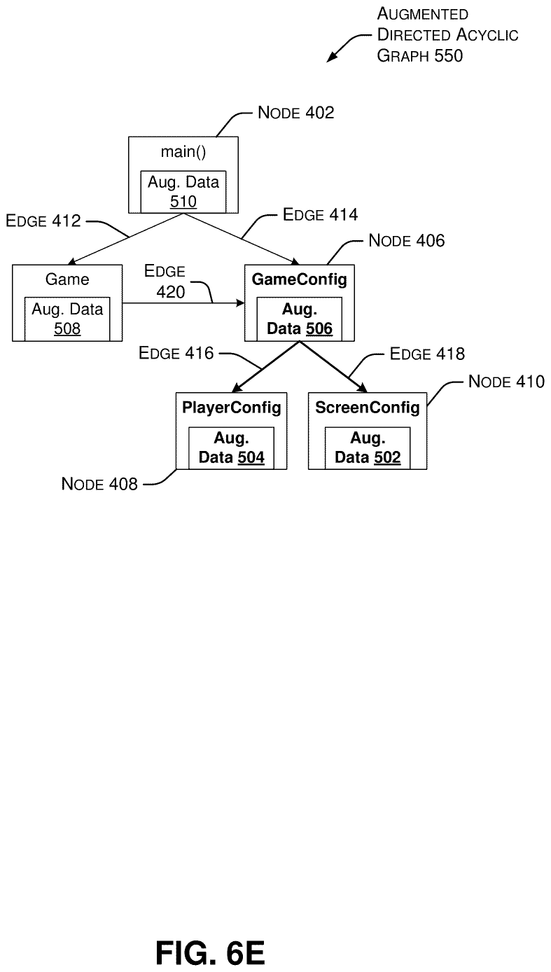

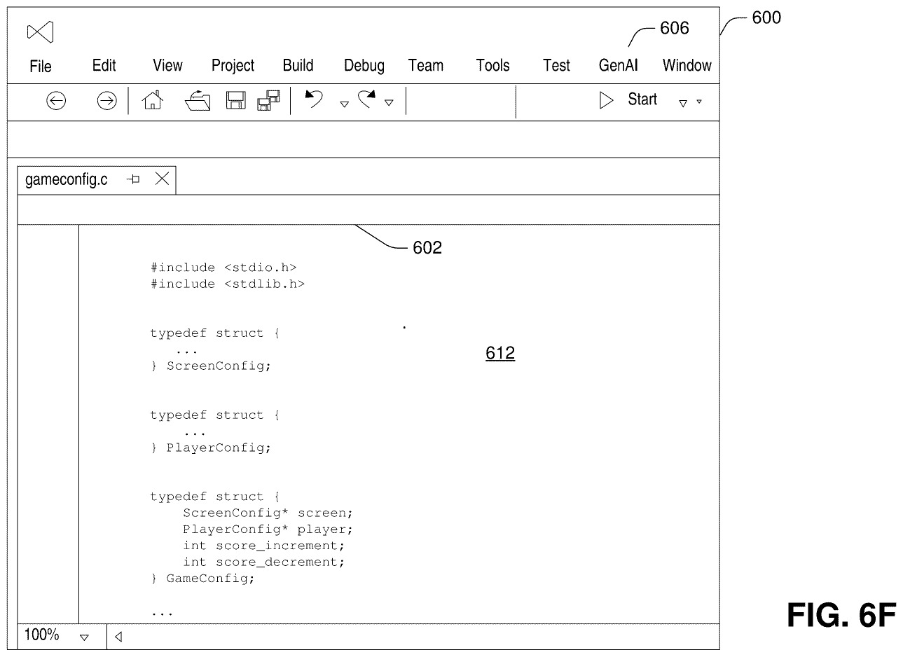

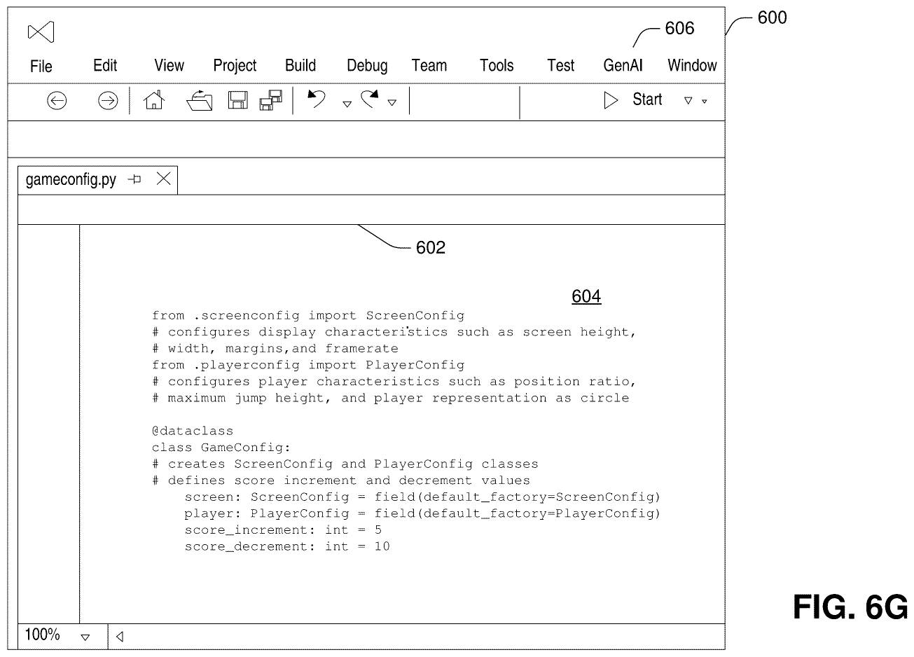

FIGS. 6A-6G illustrate examples of how an augmented directed acyclic graph can be employed for specific operations on source code by a generative language model, such as code translation and code documentation.

FIG. 6A illustrates a development environment interface 600 with a code editor 602 that can be used to enter source code 604 for a program. Continuing with the examples from above, FIG. 6A shows a user editing a source code file named “config.py,” which defines the GameConfig class described previously. Note that the GameConfig class imports the ScreenConfig and PlayerConfig classes described previously, and creates instances of those classes.

The development environment interface can include a selectable GenAI element 606 that can be used by a developer to invoke certain operations using a generative language model. FIG. 6B shows a scenario where the user hovers a cursor 608 over the GenAI element and a drop-down menu 610 appears with three options-translate to C, fix bugs, and document. Assume the user selects translate to C.

The following describes how augmented directed acyclic graph 550 can be employed to guide a generative language model to translate gameconfig.py (a source code file written in Python) into a .c file written in C. First, the breadth-first search algorithm described above can add node 406 to the set, since node 406 represents the GameConfig class to be translated. FIG. 6C illustrates this by showing node 406 in bold.

Continuing with the breadth-first search algorithm described previously, node 408 is identified in the augmented directed acyclic graph 500 as having a direct edge to node 406. Thus, node 408 is added to the set R. FIG. 6D illustrates this by showing node 408 in bold.

Continuing with the breadth-first search algorithm described previously, node 410 is identified in the augmented directed acyclic graph 500 as having a direct edge to node 406. Thus, node 410 is added to the set R. FIG. 6E illustrates this by showing node 410 in bold.

At this point, the set R includes nodes 406, 408, and 410. A generative language model can be prompted with the augmentation data for each of these nodes, e.g., augmentation data 506 for node 406, augmentation data 504 for node 408, and augmentation data 502 for node 410. Alternatively or in addition, the generative language model can be prompted with the source code represented by each of these nodes. The prompt can include a request to translate the code for the GameConfig class into C code.

FIG. 6F shows example translated code 612, produced by the generative language model. Since C is not an object-oriented language, the generative language model has used struct data types to represent the ScreenConfig, PlayerConfig, and GameConfig classes. The generative language model has also included some appropriate header files to include libraries to compile with the new C file, named gameconfig.c.

FIG. 6G shows another example user experience where a similar approach is employed to generate code documentation instead of translating code. Here, the generative language model can be provided with the same context data from the augmented directed acyclic graph 550. For instance, the generative language model can be provided augmentation data 506 for node 406, augmentation data 504 for node 408, and augmentation data 502 for node 410. Alternatively or in addition, the generative language model can be prompted with the source code represented by each of these nodes. In this case, however, the prompt requests that the generative language model add comments to the gameconfig.py file.

In FIG. 6G, the comments generated by the generative language model are preceded by a “#” symbol. Note that the comments do not merely describe the GameConfig class itself, but also include comments describing the functionality of the ScreenConfig and PlayerConfig classes. This is feasible because the augmentation data provided to the generative language model does not merely describe the GameConfig class, but also includes augmentation data for the PlayerConfig and ScreenConfig classes. Said another way, by traversing augmented directed acyclic graph 550 using the breadth-first search algorithm outlined above, a pertinent subset of the available augmentation data can be selected and provided to the generative language model, while omitting potentially-irrelevant information such as augmentation data for the main() function and/or Game class.

### Additional Use Cases

Code translation and documentation by adding comments to source code are only two of many potential operations that can be performed with a generative language model. The following describes several additional examples of how the disclosed techniques can employ an augmented directed acyclic graph for operations on source code.

Consider a scenario where a user wishes to refactor source code without necessarily changing the programming language that the source code is written in. For instance, a developer may wish to port a Windows application written in C to a different operating system, such as Linux. The disclosed techniques can be employed to iteratively select subsets of nodes from an augmented directed acyclic graph representing the Windows version of the application, provide those nodes to a generative language model with a request to translate them for use with a specific Linux distribution. In cases where there is no direct counterpart to a particular Windows application programming interface, the generative language model can be instructed to generate placeholder calls and/or comments indicating where human developers should focus their efforts to complete the generated code.

As another example, consider a tech company that acquires a source code base for a legacy application in a language such as C++. The tech company might have a developer standards guide that they use to ensure consistent company-wide coding standards, such conventions for variable prefixes that correspond to a layer of code. One example could be all variables in a device driver layer start with a “dd” prefix, whereas all variables in a graphical user interface layer start with a “gu” prefix. The generative language model could be instructed to refactor legacy code consistent with the development guidelines.

As another example, consider code optimization. Consider an application that executes correctly but uses a great deal of stack memory at runtime due to large data structures being passed on the stack. The generative language model could be instructed to replace all pass-by-value calls using data structures larger than a specific size (e.g., 64 bytes) with pass-by-reference calls that only pass a pointer on the stack.

As another example, consider unit test generation. A generative language model could be instructed to generate unit tests for a given function in a code base. The generative language model could be further instructed to ensure that the unit tests exercise all available paths that are identified not only in the source code/augmentation data for the node being considered, but also all dependencies of that node. Thus, for instance, consider prompting a generative language model to generate unit tests for a first function that calls a second function, where the second function calls a third function. The third function has an if-then statement. By providing augmentation data and/or source code for the third function, the generative language model can identify unit tests for the first function that will exercise both paths of the if-then statement in the third function. In some cases, the prompt can explicitly instruct the generative language model to ensure that the unit tests explore all paths in the code, including all cases of a switch statement, all iterations of a loop, etc.

A related use case involves unit test augmentation. Consider a scenario where a number of unit tests have already been generated by a human for the first function. The generative language model can be prompted to generate unit tests that fix gaps in the coverage of the existing unit tests, e.g., by only generating unit tests that cover paths that are unexercised by the existing unit tests.

Another related use case involves test plan generation. For instance, the generative language model could generate a test plan for a code base that involves separately testing individual layers of an application. For instance, the test plan could involve testing user-facing components of the application to ensure they are displayed properly on different types of devices with different screen sizes and resolution, and testing underlying mathematical routines for exceptions such as dividing by zero errors.

Further use cases can involve generating code documentation in the form of a separate document instead of comments, runtime completion of code, question-and-answer sessions involving a code base, etc. Generally speaking, the procedures outlined above can be employed to identify pertinent information from an augmented directed acyclic graph, and then providing that information to a generative language model with an appropriate prompt to achieve almost any generative task relating to source code.

### Algorithmic Variations

In the examples described above, the breadth-first search algorithm started from a single node corresponding to a particular source code entity. In further implementations, some use cases can begin by starting with multiple nodes instead of a single node. For instance, consider a scenario where a developer wishes to translate a particular subsystem of a code base into a different language. The subsystem has two high-level files with a number of other files having helper functions and/or classes. In this case, the breadth-first search could start with both of the higher-level files, and/or by extracting all entities from the higher-level files. The breadth-first search could involve identifying dependencies of each node representing either the files themselves and/or the entities extracted from those files. In the case where the entities themselves are employed, the fact that certain entities are identified in the same source code file is employed as a heuristic for grouping these entities together when performing a particular operation on the source code.

As another variation, note that the breadth-first search algorithm introduced above has a depth parameter. For instance, consider a very large augmented directed acyclic graph with thousands of nodes arranged in hundreds of layers. Resolving every single dependency of a relatively high-level node could still result in impractical amounts of augmentation data and/or source code considering the analytical and contextual window limitations of the generative language model. Thus, in some implementations a specified depth is employed so that dependencies only up to a given depth are employed. For instance, given a depth of two, only children and grandchildren nodes would be considered.

As another variation, note that generating an augmented directed acyclic graph can be performed as a preprocessing step in some implementations. Thus, the augmented directed acyclic graph for a given code base can be completed, and then subsequent operations performed as described previously. In other implementations, a lazy generation approach is employed. For instance, consider a code base that evolves rapidly. Whenever a given entity in the source code is modified, the process outlined above can be performed for the node representing that entity and a specified depth of dependencies from that node.

In addition, note that some implementations can group individual nodes of the augmented directed acyclic graph together based on one or more criteria. For instance, in some implementations, the nodes can be grouped together according to a community detection technique, e.g., using the Leiden algorithm. This involves partitioning the directed acyclic graph into a set of communities, each of which can contain a subset of nodes from the augmented directed acyclic graph. For instance, node 402 and node 404 of directed acyclic graph 500 could be partitioned into a first community, and node 406, node 408, and node 410 could be partitioned into a second community.

This approach can provide a supplemental or alternative structure for performing any of the subsequent operations on source code mentioned elsewhere herein. For instance, assume a request is received to perform an operation on a particular entity in source code. Some implementations can identify all other nodes that are in the same community with that entity, and then provide augmentation data for those community nodes to the generative language model when prompting the generative language model to perform a particular operation. In addition, graph traversals can be performed over connected communities to obtain augmentation data for nodes in the connected communities, in addition to or as an alternative to traversing individual nodes of the directed acyclic graph. The use of augmentation data from communities in this regard can be particularly useful in instances when two entities that are relatively far apart in the directed acyclic graph nevertheless are part of the same or within two relatively close communities, because this allows the generative language model to receive augmentation data from relevant but distant entities when performing a given operation. Additional information on community generation can be found at U.S. patent application Ser. No. 18/528,629 (Attorney Docket No. 413740-US01), entitled “Knowledge Graph Extraction,” filed on Dec. 4, 2023, and U.S. patent application Ser. No. 18/528,634 (Attorney Docket No. 413742-US02), entitled “Knowledge Graph Extraction,” filed Dec. 4, 2023. The entirety of these applications are incorporated by reference herein.

### Example System

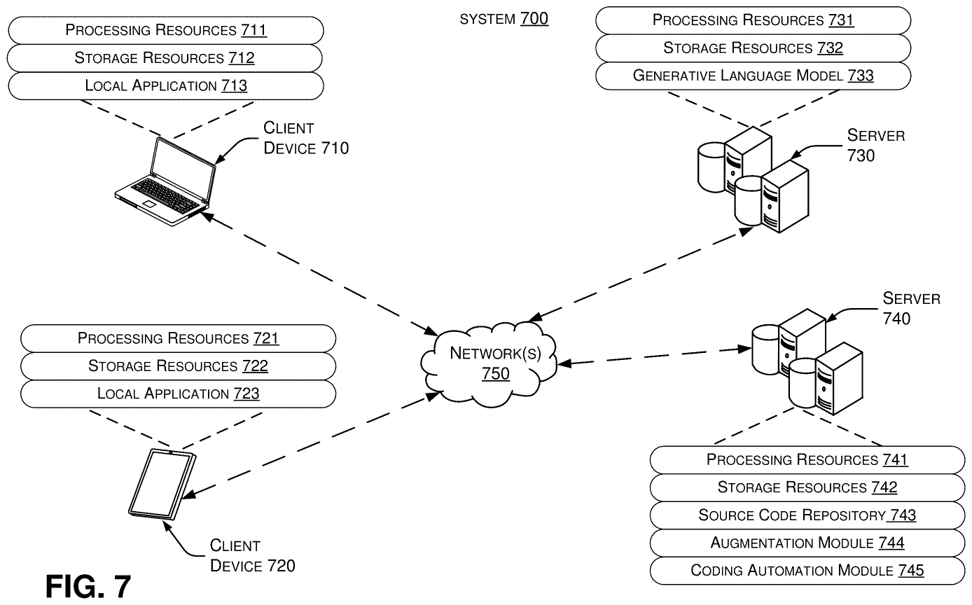

The present implementations can be performed in various scenarios on various devices. FIG. 7 shows an example system 700 in which the present implementations can be employed, as discussed more below.

As shown in FIG. 7, system 700 includes a client device 710, a client device 720, a server 730, and a server 740, connected by one or more network(s) 750. Note that the client devices can be embodied as mobile devices such as smart phones or tablets, as well as stationary devices such as desktops, etc. Likewise, the servers can be implemented using various types of computing devices. In some cases, any of the devices shown in FIG. 7, but particularly the servers, can be implemented in data centers, server farms, etc.

Client device 710 can have processing resources 711 and storage resources 712, client device 720 can have processing resources 721 and storage resources 722, server 730 can have processing resources 731 and storage resources 732, and server 740 can have processing resources 741 and storage resources 742. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include a local application 713 and client device 720 can include a local application 723 For instance, the local applications can be integrated development environments, code editors, etc. Server 730 can host generative language model 733. Server 740 can host a source code repository 743, an augmentation module 744, and a coding automation module 745.

The various devices of system 700 can interact as follows. The local applications 713 and/or 723 on the client devices can be used to edit source code and upload the source code to the source code repository 743. The augmentation module 744 can analyze the source code to create an augmented data structure representing relationships in the source code, such as a directed acyclic graph. The augmentation model can also interact with the generative language model 733 to obtain hierarchical augmentation data relating to individual entities in the source code and augment the directed acyclic graph with the augmentation data.

Then, the local applications can also allow users of the respective client devices to request operations to perform on the source code, e.g., by sending requests to the coding automation module 745. The coding automation module can implement the concepts described above for guiding the generative language model using the augmented directed acyclic graph for retrieval-augmented generation. The coding automation module can identify a set of nodes R pertaining to a given request and then prompt the generative language model using augmentation data for the nodes in R, and/or the source code for those nodes. The generative language model can perform various operations on the source code based on the received prompt, source code, and/or augmentation data. In cases involving updates to the source code itself, the updated source code can be added to the source code repository.

### Example Method

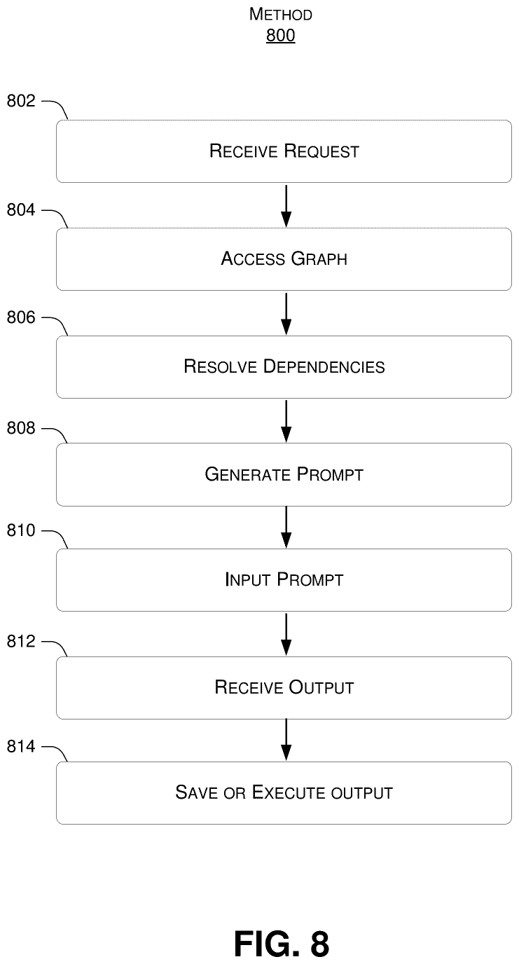

FIG. 8 illustrates an example computer-implemented method 800, consistent with some implementations of the present concepts. Method 800 can be implemented on many different types of devices, e.g., by one or more cloud servers, by a client device such as a laptop, tablet, or smartphone, or by combinations of one or more servers, client devices, etc.

Method 800 begins at block 802, where a request to perform an operation on source code is received. As noted above, the source code can be provided in procedural languages, object-oriented languages, functional languages, assembly languages, markup languages, and/or any other type of computer programming language used by human developers to write software. The request can identify a particular entity in the source code, such as a function, a class, a file, or a variable.

Method 800 continues at block 804, where a graph is accessed. The graph can have nodes representing the entities in the source code and edges representing relationships among the entities. The graph can be an augmented directed acyclic graph having augmentation data for the entities. As noted above, the augmentation data can be created by prompting a generative language model to summarize individual entities in the source code. The augmentation data can be hierarchical, starting with leaf nodes of the graph and then propagating information upward toward the root node of the graph. Thus, the information provided in the augmentation data for one node can include information from augmentation data for other nodes at different (e.g., deeper) layers of the graph.

Method 800 continues at block 806, where dependencies of the particular entity are resolved by traversing the graph. As noted above, one way to resolve the dependencies is by a breadth-first traversal of the graph, starting with a node representing the particular entity. The traversal can be limited to a specified depth.

Method 800 continues at block 808, where a prompt is generated to perform the operation. As noted above, the prompt can include information based on the dependencies, such as augmentation data and/or source code for entities that are dependent on the particular entity that is the subject of the request. The prompt can also identify the requested operation, e.g., source code translation, refactoring, unit test generation or augmentation, generation of documentation, etc.

Method 800 continues at block 810, where the prompt is input to the generative language model. For instance, the prompt can be sent out over a network to a server executing the generative language model, or provided by in-memory communication to a local model executing on the same device.

Method 800 continues at block 812, where output corresponding to the operation is received from the generative language model. For instance, the output can include translated source code for the particular entity, refactored source code for the particular entity, unit tests or documentation for the particular entity, etc.

Method 800 continues at block 814, where the output can be saved and/or executed. For instance, if the output is translated or refactored source code, the output can be compiled or interpreted into a binary and executed. If the output includes a test case, the test case can be executed. If the output includes natural language documentation in a separate file, the file can be saved in in association with the code base, etc.

In some cases, some or all of method 800 is performed by a server. In other cases, some or all of method 800 is performed on another device, e.g., a client device, or distributed across multiple devices.

### Technical Effect

As noted previously, generative language models have certain limitations, such as the number of tokens that fit into the context window. In many cases, developers will wish to perform operations on a source code base that far exceeds the size of the context window of the source code base. It is impractical to manually select individual lines of source code to prompt a generative language model for tasks such as code translation, unit test generation, bug fixes, or code documentation.

Furthermore, even assuming an entire code base could fit into the context window of a generative language model, this would be unlikely to result in high-quality results. Generative language models can struggle to perform complex analysis that involves multiple steps, and this is even more apparent for difficult tasks relating to programming languages.

The disclosed techniques leverage the inherent structural relationships expressed in source code to generate a graph that represents those relationships in a compact manner. Then, the graph is augmented using a bottom-up traversal where the generative language model provides augmentation data for each node in the graph. By starting at deeper layers of the graph and moving upward, the augmentation data carries dependency information up to higher levels of the graph.

Subsequently, a user can request that the generative language model perform specific operations relating to the source code. A relevant subset of nodes from the augmented directed acyclic graph can be selected. Augmentation data and/or source code from that subset of nodes can be retrieved and provided to the generative language model with a request to perform those specific operations. Thus, the generative language model is provided with a compact set of relevant data for performing those operations, effectively filtering out extraneous information from unrelated nodes in the graph.

This approach allows the generative language model to focus on relevant information for a given node, considering nearby dependencies while effectively ignoring information from nodes further away in the graph. This results in more accurate generation of output by the generative language model. In addition, this approach saves significant processing, memory, storage, and/or network resources compared to approaches that prompt the model with extraneous information from the code base.

### Example Decoder-Based Generative Language Model

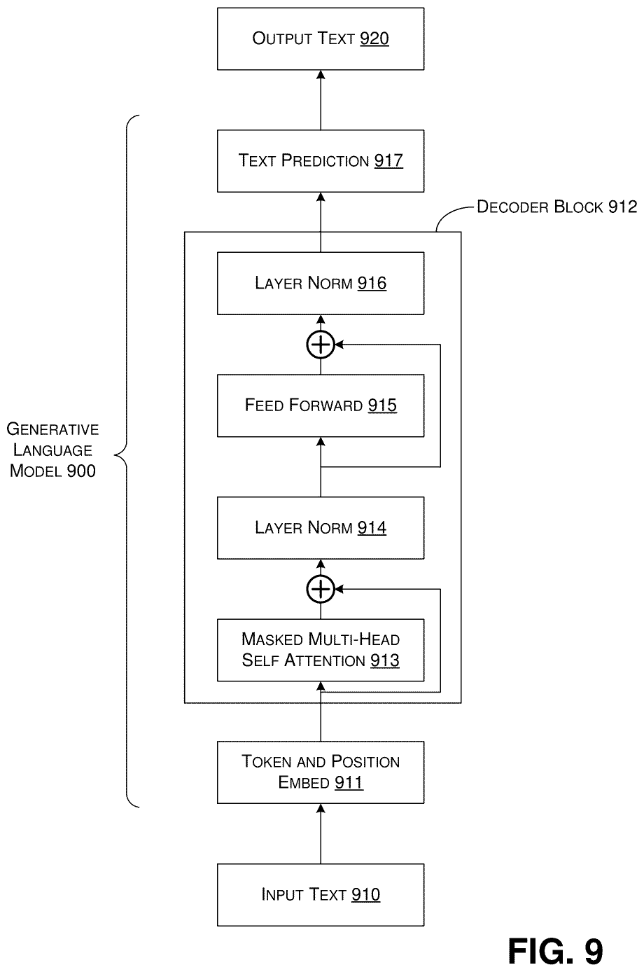

FIG. 9 illustrates an exemplary generative language model 900 (e.g., a transformer-based decoder) that can be employed using the disclosed implementations. (Radford, et al., “Improving language understanding by generative pre-training,” 2018). Generative language model 900 is an example of a machine learning model that can be used to perform one or more natural language processing tasks that involve generating text, as discussed more below. For the purposes of this document, the term “natural language” means language that is normally used by human beings for writing or conversation.

Generative language model 900 can receive input text 910, e.g., a prompt from a user or a prompt generated automatically by machine learning using the disclosed techniques. For instance, the input text can include words, sentences, phrases, or other representations of language. The input text can be broken into tokens and mapped to token and position embeddings 911 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 911 are processed in one or more decoder blocks 912. Each decoder block implements masked multi-head self-attention 913, which is a mechanism relating different positions of tokens within the input text to compute the similarities between those tokens. Each token embedding is represented as a weighted sum of other tokens in the input text. Attention is only applied for already-decoded values, and future values are masked. Layer normalization 914 normalizes features to mean values of 0 and variance to 1, resulting in smooth gradients. Feed forward layer 915 transforms these features into a representation suitable for the next iteration of decoding, after which another layer normalization 916 is applied. Multiple instances of decoder blocks can operate sequentially on input text, with each subsequent decoder block operating on the output of a preceding decoder block. After the final decoding block, text prediction layer 917 can predict the next word in the sequence, which is output as output text 920 in response to the input text 910 and also fed back into the language model. The output text can be a newly-generated response to the prompt provided as input text to the generative language model. As discussed more below, in some implementations, the output text can include image generation prompts for completing a three-dimensional virtual space based on one or more input images.

Generative language model 900 can be trained using techniques such as next-token prediction or masked language modeling on a large, diverse corpus of documents. For instance, the text prediction layer 917 can predict the next token in a given document, and parameters of the decoder block 912 and/or text prediction layer can be adjusted when the predicted token is incorrect. In some cases, a generative language model can be pretrained on a large corpus of documents. In some cases, a generative language model can be trained to predict multiple output tokens in a single inference step (Gloeckle, et al., “Better & faster large language models via multi-token prediction,” Apr. 30, 2024, arXiv preprint arXiv:2404.19737). After pretraining, the generative language model can be tuned using a reinforcement learning technique such as reinforcement learning from human feedback (“RLHF”).

### Device Implementations

As noted above with respect to FIG. 7, system 700 includes several devices, including a client device 710, a client device 720, a server 730, and a server 740. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### Additional Examples

Various examples are described above. Additional examples are described below. One example includes a computer-implemented method comprising receiving a request to perform an operation on source code having entities, the request identifying a particular entity in the source code, accessing a graph having nodes representing the entities in the source code and edges representing relationships among individual entities, resolving dependencies of the particular entity by traversing the graph, generating a prompt requesting a generative language model to perform the operation, the prompt being based at least on the requested operation and the dependencies, inputting the prompt to the generative language model, and receiving, from the generative language model, output corresponding to the requested operation.

Another example can include any of the above and/or below examples where the graph is a directed acyclic graph.

Another example can include any of the above and/or below examples where the directed acyclic graph is an augmented directed acyclic graph having augmentation data for individual nodes.

Another example can include any of the above and/or below examples where the augmentation data having been generated by the generative language model.

Another example can include any of the above and/or below examples where the generated augmentation data comprising summaries for individual entities.

Another example can include any of the above and/or below examples where the summaries including hierarchical summaries including information pertaining to dependencies of respective entities.

Another example can include any of the above and/or below examples where the method further comprises including, in the prompt, respective summaries for the particular entity and the dependencies of the particular entity.

Another example can include any of the above and/or below examples where the method further comprises including, in the prompt, source code for the particular entity and the dependencies of the particular entity.

Another example can include any of the above and/or below examples where the method further comprises grouping multiple nodes according to a heuristic to identify a group of related nodes, resolving further dependencies of each of the multiple nodes of the group, and generating the prompt based at least on the further dependencies.

Another example can include any of the above and/or below examples where the heuristic relating to entities that are identified in a particular source code file with the particular entity or that share a tag with the particular entity.

Another example can include any of the above and/or below examples where the heuristic relating to other entities that are part of a particular community of which the particular entity is a member.

Another example can include a system comprising a processor and a storage medium storing instructions which, when executed by the processor, cause the system to receive a request to perform an operation on source code having entities, the request identifying a particular entity in the source code, access a graph having nodes representing the entities in the source code and edges representing relationships among individual entities, resolve dependencies of the particular entity by traversing the graph, generate a prompt requesting a generative language model to perform the operation, the prompt being based at least on the requested operation and the dependencies, input the prompt to the generative language model, and receive, from the generative language model, output corresponding to the requested operation.

Another example can include any of the above and/or below examples where the operation comprises code translation of the source code for the particular entity into a different programming language.

Another example can include any of the above and/or below examples where the instructions, when executed by the processor, cause the system to obtain translated source code in the different programming language from the generative language model, interpret or compile the translated source code into binary code, and execute the binary code.

Another example can include any of the above and/or below examples where the operation comprises code refactoring of the source code for the particular entity.

Another example can include any of the above and/or below examples where the operation comprises unit test generation or unit test augmentation for the source code for the particular entity.

Another example can include any of the above and/or below examples where the operation involves natural language documentation of the source code for the particular entity.

Another example can include any of the above and/or below examples where the natural language documentation comprises comments added to the source code for the particular entity or a separate document describing the source code for the particular entity.

Another example can include any of the above and/or below examples where the graph is an augmented directed acyclic graph and the prompt includes augmentation data for the particular entity and the dependencies, the augmentation data having been generated by the generative language model.

Another example can include a computer-readable storage medium storing instructions which, when executed by a processing device, cause the processing device to perform acts comprising receiving a request to perform an operation on source code having entities, the request identifying a particular entity in the source code, accessing a graph having nodes representing the entities in the source code and edges representing relationships among individual entities, resolving dependencies of the particular entity by traversing the graph, generating a prompt requesting a generative language model to perform the operation, the prompt being based at least on the requested operation and the dependencies, inputting the prompt to the generative language model, and receiving, from the generative language model, output corresponding to the requested operation.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving a request to perform an operation on source code having entities, the request identifying a particular entity in the source code;
accessing a graph having nodes representing the entities in the source code and edges representing relationships among individual entities;
resolving dependencies of the particular entity by traversing the graph;
generating a prompt requesting a generative language model to perform the operation, the prompt being based at least on the requested operation and the dependencies;
inputting the prompt to the generative language model; and
receiving, from the generative language model, output corresponding to the requested operation.

2. The computer-implemented method of claim 1, wherein the graph is a directed acyclic graph.

3. The computer-implemented method of claim 2, wherein the directed acyclic graph is an augmented directed acyclic graph having augmentation data for individual nodes.

4. The computer-implemented method of claim 3, the augmentation data having been generated by the generative language model.

5. The computer-implemented method of claim 4, the generated augmentation data comprising summaries for individual entities.

6. The computer-implemented method of claim 5, the summaries including hierarchical summaries including information pertaining to dependencies of respective entities.

7. The computer-implemented method of claim 5, further comprising:
including, in the prompt, respective summaries for the particular entity and the dependencies of the particular entity.

8. The computer-implemented method of claim 5, further comprising:
including, in the prompt, source code for the particular entity and the dependencies of the particular entity.

9. The computer-implemented method of claim 1, further comprising:
grouping multiple nodes according to a heuristic to identify a group of related nodes;
resolving further dependencies of each of the multiple nodes of the group; and
generating the prompt based at least on the further dependencies.

10. The computer-implemented method of claim 9, the heuristic relating to entities that are identified in a particular source code file with the particular entity or that share a tag with the particular entity.

11. The computer-implemented method of claim 9, the heuristic relating to other entities that are part of a particular community of which the particular entity is a member.

12. A system comprising:
a processor; and
a storage medium storing instructions which, when executed by the processor, cause the system to:
receive a request to perform an operation on source code having entities, the request identifying a particular entity in the source code;
access a graph having nodes representing the entities in the source code and edges representing relationships among individual entities;
resolve dependencies of the particular entity by traversing the graph;
generate a prompt requesting a generative language model to perform the operation, the prompt being based at least on the requested operation and the dependencies;
input the prompt to the generative language model; and
receive, from the generative language model, output corresponding to the requested operation.

13. The system of claim 12, the operation comprising code translation of the source code for the particular entity into a different programming language.

14. The system of claim 13, wherein the instructions, when executed by the processor, cause the system to:
obtain translated source code in the different programming language from the generative language model;
interpret or compile the translated source code into binary code; and
execute the binary code.

15. The system of claim 12, the operation comprising code refactoring of the source code for the particular entity.

16. The system of claim 12, the operation comprising unit test generation or unit test augmentation for the source code for the particular entity.

17. The system of claim 12, the operation involving natural language documentation of the source code for the particular entity.

18. The system of claim 17, the natural language documentation comprising comments added to the source code for the particular entity or a separate document describing the source code for the particular entity.

19. The system of claim 12, wherein the graph is an augmented directed acyclic graph and the prompt includes augmentation data for the particular entity and the dependencies, the augmentation data having been generated by the generative language model.

20. A computer-readable storage medium storing instructions which, when executed by a processing device, cause the processing device to perform acts comprising:
receiving a request to perform an operation on source code having entities, the request identifying a particular entity in the source code;
accessing a graph having nodes representing the entities in the source code and edges representing relationships among individual entities;
resolving dependencies of the particular entity by traversing the graph;
generating a prompt requesting a generative language model to perform the operation, the prompt being based at least on the requested operation and the dependencies;
inputting the prompt to the generative language model; and
receiving, from the generative language model, output corresponding to the requested operation.
